(19) United States
(12) Patent Application Publication
(10) Pub. No.: US 2009/0101174 A1
(43) Pub. Date: Apr. 23, 2009

(54) DISHWASHER HAVING IMPROVED HEAT RECOVERY

(76) Inventors: Bruno GAUS, Offenburg (DE); Joachim Kupetz, Berghaupten (DE); Denis Lehmann, Ortenberg (DE); Thomas Naeger, Offenburg (DE); Thomas Peukert, Buehl (DE); Vera Schneider, Offenburg (DE)

Correspondence Address: Muncy, Geissler, Olds & Lowe, PLLC, P.O. BOX 1364, FAIRFAX, VA, 22038-1364, US

(21) Appl. No.: 12/254,059

(22) Filed: Oct. 20, 2008

(30) Foreign Application Priority Data
Oct. 19, 2007 (DE) 10 2007 050 533.9
Jun. 5, 2008 (DE) 10 2008 026 875.5

(51) Int. Cl. B08B 3/10; F28F 13/12; G05D 23/00

(52) U.S. Cl. 134/18; 134/107

(57) ABSTRACT

A cleaning appliance for cleaning of cleaning stock is provided, which is set up in order to act with at least one cleaning fluid upon the cleaning stock in at least one cleaning chamber. The cleaning appliance has at least one fluid tank for storing the cleaning fluid. Furthermore, the cleaning appliance has a suction-extraction device for the suction-extraction of moist air from the cleaning chamber and also has at least one heat recovery device. The heat recovery device is set up in order to extract heat from the moist air. The heat recovery device has at least one Peltier element, which has a heat-absorption side and a waste-heat side. The waste-heat side is in thermal contact with a fluid heating device. The fluid heating device is, in turn, in contact with a first cooling fluid and is set up in order to heat this first cooling fluid. The cleaning appliance is set up, furthermore, in order to use the first cooling fluid for a cleaning process.

This nonprovisional application claims priority under 35 U.S.C. § 119(a) to German Patent Application Nos. DE 10 2007 050 533.9 and DE 10 2008 026 875.5, which were filed in Germany on Oct. 19, 2007 and Jun. 5, 2008, respectively, and which are both herein incorporated by reference.

### FIELD OF THE INVENTION

The invention relates to a cleaning appliance for the cleaning of cleaning stock in a cleaning chamber, the cleaning appliance having a heat recovery device. The invention relates, furthermore, to a method for heat recovery in a cleaning appliance. Such cleaning appliances and methods for heat recovery are employed, for example, in canteens for the cleaning of utensils, glasses, cups, cutlery, trays or similar cleaning stock. However, other fields of use and types of cleaning stock, particularly in the commercial sector, may also be envisaged.

### DESCRIPTION OF THE BACKGROUND ART

From the most diverse possible sectors of technology and natural sciences, cleaning appliances are known, by means of which various types of cleaning stock can be cleaned with different objectives in view. One objective is, for example, the at least substantial freeing of adhering dirt residues from the cleaning stock, and another objective, which may be implemented alternatively or additionally, is the hygienization of the cleaning stock which may amount to a disinfection of the cleaning stock. Cleaning takes place, as a rule, by the action upon the cleaning stock of at least one cleaning fluid which may comprise, for example, a liquid cleaning fluid (for example, one or more washing liquids, for example water mixed with a cleaning agent and/or with a rinse aid) and/or a gaseous cleaning fluid, such as, for example, steam.

In many instances, in a cleaning appliance of this type, a considerable quantity of thermal energy has to be applied. This thermal energy may be required directly during the cleaning process, for example in that the cleaning fluid is applied at an increased temperature to the cleaning stock. For example, for a rinsing operation in a dishwasher, rinsing liquids having a temperature of approximately 85° C. may be used. A further example is the thermal energy which is required for generating the steam in steam sterilizers and/or steam disinfection appliances. Furthermore, cleaning appliances may also be set up in such a way that one or more drying steps are carried out. In such drying, for example, the cleaning stock may be acted upon with hot air, for which purpose thermal energy likewise has to be expended.

Particularly in the commercial sector, this outlay in terms of thermal energy may assume a considerable order of magnitude, and therefore, for example, heating capacities may make a considerable contribution to the overall operating costs of the cleaning appliance. In commercial dishwashers, the heating capacities range, for example, from a few 10 kW to a few 100 kW, depending, for example, on the operating state and/or the configuration of the dishwasher.

A further problem in known cleaning appliances, particularly in the sector of commercial use, is that, as a rule, these are used in a work environment which should not be loaded excessively by waste heat from the cleaning appliance, particularly by moist waste heat. Thus, for example, in canteens, a considerable outlay is required in order to avoid conducting moist waste heat, formed in the dishwashers, directly into the work environment, since the working conditions in this work environment would otherwise become unreasonable within a short time. To that extent, for example, complicated on-site exhaust-air devices are required in order to discharge the moist waste heat out of the work environment. Alternatively or additionally, the cleaning appliances may have drying devices, in order to extract moisture from the exhaust air and/or to cool the exhaust air.

Numerous drying devices which assist the drying of the cleaning stock and dehumidify the exhaust air emitted into the surroundings are known from the prior art. An example of a drying device of this type which operates with the aid of Peltier elements is known from DE 198 13 924 A1. This publication shows a condensation device for a domestic appliance, comprising a module element with a Peltier element. The Peltier element has a heat-absorbing surface and a heat-emitting surface. The heat-absorbing surface extracts heat from a work-space atmosphere of a workspace of the domestic appliance, with the result that moisture from the work-space atmosphere condenses at the cooled location and therefore a drying operation of the domestic appliance is more effective and quicker. The heat-emitting surface of the Peltier element may also be coupled to a heat-absorbing volume, such as, for example, a water tank.

The device described in DE 198 13 924 A1, however, has the disadvantage from the point of view of commercial practicability that, if the Peltier element heats up to too great an extent, the water tank for cooling the latter has to be emptied and filled with fresh water. To that extent, on the one hand, the functionality of the condensation device is unstable and may fluctuate over a relatively long operating time. Particularly in commercial cleaning appliances which, for example, have to operate continuously for several hours, this may be a considerable disadvantage. Moreover, a safe and reliable drying operation is not ensured in all instances because of the described temperature drift in the water tank. Furthermore, the energy contained in the waste heat is lost, and even additional energy has to be expended in order to operate the Peltier element.

From the sector of air-conditioning technology, too, cooling appliances are known in which Peltier elements are used for the conditioning of room air and other media. Thus, for example, EP 0 842 382 B1 describes a compact H-thermal appliance which consists of thermocouple blocks having a plurality of Peltier elements. In this case, thermal energy is transferred from a medium on a cold side to a medium on a hot side. It is in this case proposed, inter alia, to collect the hot water which has occurred as service water and make it available for further use. Overall, however, the set-up described in EP 0 842 382 B1 is comparatively complex.

From the sector of commercial dishwashers, cleaning appliances are known which not only attempt to mitigate the described problem of loading the surroundings with exhaust air, but are also designed for allowing at least partial heat recovery of the thermal energy contained in the waste heat. An example of systems of this type is illustrated in U.S. Pat. No. 3,598,131. In this, by means of a suction-extraction device, steam is suction-extracted out of a dishwasher into a shaft and is conducted via a heat exchanger. The heat exchanger is in this case configured as porous material which is sprayed with fresh water. The condensed moisture is collected and is supplied to the dishwasher again. A similar dishwasher with heat recovery is also illustrated in DE 10 2004 003 797 A1, which corresponds to U.S. Publication No. 20070131260.

The disadvantage of the cleaning appliance illustrated in U.S. Pat. No. 3,598,131, however, is that the functionality of the heat recovery device depends greatly on the temperature of the cold water sprayed on. If, for example, the dishwasher is operated in regions with a hot climate, then, usually, the “cold water” has a different temperature from that in regions with a milder or even cool climate. To that extent, the functionality of the heat recovery device may fluctuate sharply, and controlled dehumidification or cooling cannot be ensured in all cases.

A further disadvantage of the heat recovery device as shown in U.S. Pat. No. 3,598,131 is that cooling liquid is intermixed with the condensed water, and therefore, overall, the recirculated water has a comparatively low temperature and, as a rule, has to be reheated before it can be supplied to the cleaning operation again. Moreover, the heat recovery device shown has disadvantages in hygienic terms, since there is the fear of the growth of bacteria in the condensed water and therefore in the cleaning stock or the porous heat exchanger.

Furthermore, theoretically, there is a possibility of employing what are known as heat pumps for heat recovery. Heat pumps are machines which, with a delivery of mechanical work, pump heat from a low temperature level to a higher temperature level. Thus, in particular, the problem can be counteracted where cooling water, after flowing through the heat recovery device, has a comparatively low temperature and has to be heated up further after being recirculated into the cleaning appliance. In heat pumps, as a rule, evaporation heat is utilized in order, for example, to extract a heat quantity from the waste heat of a dishwasher. However, as a rule, heat pumps cannot be regulated, as required, and, in practice, have restrictions in their automatic control behavior, since only two-position control is possible. Moreover, they have a defined operating point with fixed tolerance which is not scaleable. This presents problems in many instances particularly for commercial use. Moreover, the use of heat pumps mostly entails considerable additional costs and allowing for considerable construction spaces. Further disadvantages in the use of heat pumps are the noise occurring during operation, the high mechanical wear and vibrations.

### SUMMARY OF THE INVENTION

It is therefore an object of the present invention to provide a cleaning appliance and a method for operating such a cleaning appliance, which avoid the above-described disadvantages of known cleaning appliances and/or methods. In particular, heat recovery is to be provided which can be operated in a stable and reliable way under various operating conditions, can be employed flexibly and allows an efficient recirculation of heat which can be regulated effectively, operates with low wear or free of wear and is easily scaleable.

A cleaning appliance for the cleaning of cleaning stock is proposed, which is set up in order to act with at least one cleaning fluid upon the cleaning stock in at least one cleaning chamber. The cleaning chamber may be configured to be closed (for example, with an opening mechanism for the loading and unloading of cleaning stock) and/or partially open (for example, provided with one or more loading orifices) and is to ensure that cleaning fluid cannot be splashed, unimpeded, into the work environment, and that, for example, steam vapors cannot flow out of the cleaning appliance or can flow out of the latter to only a reduced extent. The cleaning appliance may, for example, be configured basically according to one of the cleaning appliances described in the introduction. For example, the cleaning appliance may have or be a dishwasher, in particular a commercial dishwasher, although non-commercial dishwashers are also possible. Commercial dishwashers differ from domestic appliances, as a rule, in that, so that a cleaning fluid having a required cleaning temperature can be provided more quickly, a separate fluid tank (in particular, a boiler and/or a flow heater), that is to say a fluid tank separate from the cleaning chamber, is provided, whereas, in domestic appliances, a change of water usually takes place within the cleaning chamber. The dishwasher may, for example, comprise a flow-type dishwasher, in particular a belt transport machine and/or a basket transport machine. Alternatively or additionally, it may also comprise a single-chamber dishwasher, in particular, again, for commercial use, for example a single-chamber dishwasher in the form of a front loader and/or a single-chamber dishwasher in the form of a top loader and/or a hood-type dishwasher, for example a push-through hood-type dishwasher. In particular, it may comprise a commercial single-chamber dishwasher having at least one fluid tank separate from the cleaning chamber. Alternatively or additionally to at least one dishwasher, however, the cleaning appliance may also contain another type of cleaning appliance for the cleaning of cleaning stock, for example a steam disinfection appliance and/or a steam sterilizer, for example for the cleaning of medical cleaning stock occurring in hospitals and/or nursing homes. However, even other types of cleaning appliances are possible. In addition to the appliances mentioned, the cleaning appliance may comprise further devices, so that, for example, a plurality of dishwashers are combined into a washing line which may also comprise additional appliances required in canteens.

The cleaning appliance preferably comprises at least one fluid tank for storing the cleaning fluid, out of which, for example, one or more spray nozzles can then be fed with cleaning fluid. This fluid tank may be designed to be separate from the cleaning chamber and/or may also be designed as an integral part of the cleaning chamber. Furthermore, the fluid tank may be configured completely or partially as a pressure tank, but may also be configured completely or partially as a pressure-less tank. The configuration of the at least one fluid tank may be adapted to the type of cleaning appliance. If, for example, a flow-type dishwasher having one or more cleaning zones is used, then, for example, each cleaning zone and/or a plurality of cleaning zones together may be assigned a fluid tank of this type. It is particularly preferable in this case if the flow-type dishwasher is set up in such a way that cleaning stock runs through the at least one cleaning zone in a flow direction. For example, the at least one cleaning zone may comprise at least one pump rinsing zone and/or at least one fresh-water rinsing zone which has at least one rinsing tank, in which case the at least one fluid tank may, for example, comprise the at least one rinsing tank.

However, the term “fluid tank” is to be interpreted broadly and may, but does not necessarily have to, comprise a container with a widened diameter for the storage of a quantity of cleaning fluid. The fluid tank may also be integrated completely or partially into the cleaning chamber, for example in that the fluid tank is formed in a bottom region of the cleaning chamber. Alternatively or additionally, however, the at least one fluid tank may also comprise a separate tank, this being preferable particularly in commercial dishwashers. A plurality of fluid tanks may also be provided, for example for different part-processes in cleaning. If a plurality of cleaning zones are provided, then, for example, each cleaning zone may be assigned at least one fluid tank, in which case one or more of these fluid tanks may be utilized for the heat recirculation described below. Furthermore, the at least one fluid tank may comprise one or more pressure-loaded and/or pressure-less reservoirs for storing a quantity of cleaning fluid supplied via a pipeline system, but may also be configured completely or partially solely as a throughflow pipeline system in which the cleaning fluid can flow. Thus, for example, the heated first cooling fluid, after flowing through a heat recovery device (see below), may also be supplied directly to the fresh-water rinsing zone, in which case the pipeline system between the heat recovery device and fresh-water rinsing zone may be understood in a broader sense as meaning a “fluid tank”. This pipeline system may also be equipped, for example, with additional flow heaters in order to heat the first cooling fluid further. It is in this case critical, however, that the first cooling fluid heated in the heat recovery device is supplied again in any form from the fluid tank to the cleaning process, so that the heat stored in this first cooling fluid can be reutilized.

As described above, the cleaning fluid may comprise, for example, at least one liquid and/or at least one gaseous cleaning fluid. The following description will assume, without the scope of the invention being restricted, that the cleaning fluid is an aqueous cleaning fluid, such as is used, for example, in dishwashers. For example, a cleaning agent and/or a rinse aid may be admixed to this aqueous cleaning fluid. Other types of admixings and/or compositions of the cleaning fluid may, however, also be envisaged and are implementable within the scope of the present invention. In particular, the cleaning fluid may be operated at an increased temperature, as compared with room temperature, for example at temperatures in the region of 60° C. and/or temperatures in the range of 80 to 90° C., for example 85° C. The latter is favored particularly in the rinsing area. However, other types of temperature organization may likewise be envisaged.

To mitigate the above-described problem of loading the work environment of the cleaning appliance with moist air, in particular with steam vapors, the cleaning appliance has a suction-extraction device for the suction-extraction of moist air from the cleaning chamber. This suction-extraction device may, for example, have an exhaust-air orifice, through which the moist air (for example, after passing through the heat recovery device described below) is discharged from the cleaning appliance. This exhaust-air orifice may, for example, issue directly and/or via a filter into the work environment of the cleaning appliance. Alternatively or additionally, however, the at least one exhaust-air device may also be connected to an exhaust-air arrangement, provided on site, for example a venting pipe.

The terms “suction-extraction device” and “section-extraction” are again to be interpreted broadly and may, for example, include active section-extraction (for example, by means of one or more suction-extraction blowers) of the moist air. Alternatively, however, the suction-extraction device may also be configured without a blower and, for example, comprise only the at least one exhaust-air orifice. In this case, for suction-extraction purposes, for example, a vacuum prevailing on site at the exhaust-air arrangement may then be used, or, alternatively or additionally, an excess pressure of the moist air, as compared with the ambient air, or special air flows which are conducive to discharging moist air from the cleaning appliance, or, simply, a convection of the moist air. The section-extraction and suction-extraction device are therefore to be defined merely in that they allow and/or promote a discharge of the moist air from the cleaning appliance in any way.

Furthermore, the cleaning appliance has at least one heat recovery device. This heat recovery device is set up in order to extract heat from the moist air. In contrast to known heat recovery devices, such as, for example, the heat recovery device described in U.S. Pat. No. 3,598,131, however, a basic idea of the present invention is advantageously to modify known heat recovery devices, using Peltier elements, such as are known, for example, from DE 198 13 924 A1. This modification, however, takes place in such a way that the known disadvantages of the Peltier elements, for example the disadvantages described above with regard to DE 198 13 924 A1, can be avoided by means of an appropriate design.

The heat recovery device accordingly has at least one Peltier element with a heat-absorption side and with a waste-heat side. The heat-absorption side may be utilized directly or indirectly in order to extract heat from the moist air. In contrast to known Peltier dryers, such as, for example, the Peltier dryer known from DE 198 13 924 A1, with a coupling of the waste-heat side to a simple water volume, however, according to the invention a fluid heating device is provided which is in thermal contact with the waste-heat side. This fluid heating device is set up in such a way that it is in contact with a first cooling fluid, for example has flowing through it the first cooling fluid which in this case absorbs waste heat from the waste-heat side of the Peltier element. The fluid heating device is therefore configured in order to heat the first cooling fluid. In contrast to DE 198 13 924 A1, the waste heat of the Peltier element is therefore supplied at least partially again to the cleaning appliance, and the latter is set up in order to use the first cooling fluid in a subsequent cleaning process.

For example, the first cooling fluid, after flowing through the fluid heating device, may be conducted to the cleaning chamber and/or into the fluid tank and thus be usable for the cleaning operation. Alternatively, the waste heat of the Peltier element may also be transmitted directly to the fluid tank, for example in that the fluid heating device is connected directly to the fluid tank. The cleaning appliance is then preferably configured in such a way that the first cooling fluid, after flowing through the fluid heating device at the Peltier element, and therefore also the heat absorbed from this first cooling fluid are utilizable for a cleaning operation in the cleaning chamber.

The term “cleaning process” or “cleaning operation” is in this case, within the meaning of the present invention, to be interpreted broadly. It covers basically any operation in which the cleaning stock to be cleaned is acted upon with at least one cleaning fluid, in particular a cleaning liquid. This term may therefore, for example, cover any washing process, pre-clearing, coarse cleaning, pre-washing, main cleaning, after washing, rinsing or any combination of the said cleaning processes and/or other types of cleaning processes. However, even other types of cleaning processes may be envisaged.

The fluid heating device may be configured in any way which allows heat transmission between the waste-heat side of the Peltier element and the first cooling fluid. For example, it may comprise a simple heat transmission surface, for example a simple wall of a fluid tank. To that extent, the term “flow through” is also to be interpreted broadly within the meaning of the present invention. In addition to a flow which, for example, comprises a mass flow through a cooling-fluid line, the waste-heat side of the Peltier element and/or the fluid heating device may also be coupled directly to the fluid tank, so that, for example, the first fluid is heated in this fluid tank (for example, a boiler) directly by the waste heat occurring at the Peltier element, irrespective of whether the first cooling fluid is in motion in the fluid tank or not. Basically, however, the term “flow through” covers any type of transport of a cooling fluid, here of the first cooling fluid, in which the latter comes into thermal contact with a “throughflow element”, here the fluid heating device. In addition to a physical throughflow, therefore, what is also covered is an “overflow” and/or “flow along” or a flow in which the first cooling fluid flows along over one or more surfaces which are assigned directly or indirectly to the fluid heating device and allow heat transmission. Even more complex, for example indirect, heat-transmission mechanisms may be utilized and are to be covered by the term “flow through”.

A “cooling fluid” is in this case here, as below, again, to be understood, for example, as meaning a liquid and/or gaseous medium which, for example, may be configured in a similar way to the cleaning fluid described above. Since, in this case, the first cooling fluid can also actually be used as cleaning fluid in a subsequent step, the first cooling fluid may again, for example, comprise an aqueous cooling fluid, for example fresh water with an admixing of cleaning agents and/or rinse aids.

The proposed cleaning appliance thus combines the advantages of known cleaning appliances having a heat recovery device with the advantages of the known Peltier dryers, while the disadvantages of both systems can cleverly be avoided. The comparatively low efficiencies of the Peltier elements are in this case advantageously utilized, even indirectly, since the waste heat occurring can at least partially be recovered and can be supplied anew to the cleaning appliance. The recovered heat may be fed into the cleaning process directly again, which may preferably take place completely, with the exception of unavoidable insulation losses. In contrast to heat recovery devices with straightforward liquid heat exchangers, the heating of the first cooling fluid after it flows through the fluid heating device is not simply predetermined by temperature differences, but, for example, may be set by means of a corresponding activation of the Peltier element. This setting of the heating by the Peltier element is therefore a setting in an active method, not a passive method, as in a heat exchanger. To that extent, substantial independence of, for example, inlet temperatures of the first cooling fluid, for which purpose, for example, fresh water in the form of cold water may be used, can be afforded. In contrast, for example, to a conventional heat pump, the output level can be influenced, as can the temperature on the absorption side. To that extent, the cleaning appliance can be operated, for example, under different climatic conditions, without the functionality of the heat recovery device being impaired. In the heat recovery device, simultaneously with a cooling of the moist air, an at least substantial and reliable dehumidification can also take place, so that, for example, through the exhaust-air orifice, exhaust air can be discharged into the surroundings which corresponds in terms of temperature and/or moisture to predetermined limit values. Since an efficient cooling of the moist air can be ensured by means of Peltier elements, the cleaning appliance can to that extent contribute even to room air-conditioning. Moreover, Peltier elements operate silently and in a vibration-free manner and can be operated virtually free of wear.

A “Peltier element” is in this case to be understood within the scope of the present invention as meaning an electrothermal converter which is based on one or more of the following physically similar effects: the Peltier effect, the Thomson effect and the Seebeck effect. Irrespective of which of these effects is predominant in the present case, thermoelectric elements of this type are designated within the scope of the present invention as Peltier elements. In general terms, therefore, within the scope of the present invention, the term “Peltier element” covers all types of thermoelectric converters.

For example, a Peltier element of this type may comprise two or more semiconductors or other solid-state elements which have a different energy level in terms of their conduction bands. If an electrical current is conducted through two contact points of these materials which lie one behind the other, energy is absorbed at one contact point, so that electrons can pass into that conduction band of the adjacent semiconductor material which is arranged at a higher energy level. This therefore results in cooling here. At the other contact point, electrons move from a higher to a lower energy level, so that energy is emitted in the form of heat here. For example, by the electrical current being set, a cooling capacity of the Peltier element can be controlled, conventional Peltier elements typically having a predetermined maximum temperature difference between both sides (heat-absorption side and waste-heat side). For example, depending on the element and the current, in single-stage Peltier elements, the temperature difference may amount to approximately 60-70 Kelvin. According to the invention, the waste heat occurring on the waste-heat side is at least partially utilized, so that, on the one hand, the water-changing problem of the heat-absorbing volume, as described in DE 198 13 924 A1, can be avoided, and so that, on the other hand, this waste heat can even be utilized again.

In addition to “classic” thermoelectric elements of this type, however, the term “Peltier element” also embraces within the scope of the present invention other types of thermoelectric elements, such as, for example, what are known as thermionic converters. Thermionic converters of this type are based on the recognition that materials used in classic thermoelectric converters, as a rule, not only have good electrical properties, but also a comparatively high thermal conductivity. However, the result of this thermal conductivity is that a large part of the transported heat flows back again to the actually cold side. An equilibrium is established which reduces the efficiency of the classic thermoelectric elements. Thermionic converters, which are to be considered as a special case of thermoelectric converters, improve the efficiency by using thin tunnel layers, such as, for example, gaps or clearances in the structural elements, for example clearances of between 0.2 and 5 micrometers. While electrons can overcome these clearances by tunneling, these clearances act as an efficient barrier for heat conduction, so that it becomes difficult for the heat to be transported back. The equilibrium is therefore displaced in favor of a heating of the hot side of the elements, so that, overall, the efficiency of the thermoelectric elements rises. In order to make the tunneling of the electrons easier, base materials, that is to say materials with a low work function, are often used in the region of the gaps. Examples of such materials are alkaline and alkaline-earth metals or what are known as Avto metals. Modern examples of such thermionic converters, such as can be used within the scope of the present invention and likewise come under the term “Peltier elements”, are “Cool Chips”, as they are known, from the company Cool Chips plc. in Gibraltar. It may be pointed out that the at least one Peltier element may also comprise a plurality of elements operating according to various physical principles, for example a combination of “classic” Peltier elements and Cool Chips.

The cleaning appliance according to the invention may advantageously be developed in that the heat recovery device has a multi-stage set-up. This notion is based on the idea that Peltier elements, irrespective of the temperature of the medium to be cooled, can cool the medium to be cooled, the cooling being dependent, for example, solely on the applied current and/or the temperature difference between the heat-absorption side and waste-heat side. In contrast to conventional liquid heat exchangers which are used in heat recovery devices and which can operate efficiently only at as high a temperature of the moist air as possible, therefore, Peltier cooling may also be used as a following stage in a multi-stage heat recovery device in order to extract further heat from moist air which is already partially cooled.

Correspondingly, the heat recovery device may comprise, for example, additional heat exchangers which may completely or partially precede the Peltier element. For example, in this case, cooling coils, plate heat exchangers and/or irrigation heat exchangers (for example, similar to U.S. Pat. No. 3,598,131) may be employed. It is particularly preferable if the heat recovery device has at least one first fluid heat exchanger which is set up in such a way that it extracts a first heat quantity from the moist air. The heat-absorption side of the Peltier element is set up correspondingly in order to extract a second heat quantity from the moist air. As described above, this is possible due to the fact that the “thermoelectric heat pump” of the Peltier element can operate even in the case of moist air which is already partially cooled. In contrast to other types of heat pumps, however, the Peltier element can be used quickly, can be switched off and/or on at any time and requires only a small construction space. Moreover, in contrast to heat pumps, the Peltier element can be regulated preferably continuously via the current which is fed in.

In this preferred embodiment of the cleaning appliance, the first fluid heat exchanger may, in particular, have the first cooling fluid flowing through it, the first cooling fluid, after flowing through the first fluid heat exchanger, flowing through the fluid heating device of the Peltier element. This embodiment has the effect that the first heat quantity which is extracted from the moist air in the first fluid heat exchanger is absorbed by the first cooling fluid. Subsequently, the second heat quantity transmitted by the Peltier element is additionally added to this first cooling fluid, so that the first cooling fluid can be heated to comparatively high temperatures. In contrast to conventional straightforward liquid heat exchangers, therefore, the cooling fluid can be heated even at least approximately to the temperatures required in a subsequent cleaning of the cleaning stock or even above these temperatures, so that a particularly high energy efficiency of the cleaning appliance can be ensured.

The above-described multi-stage principle of the heat recovery device may, of course, also be extended, for example from the one first fluid heat exchanger described, which is followed by a Peltier element, to a plurality of fluid heat exchangers connected one behind the other and/or a plurality of Peltier elements connected one behind the other.

The first fluid heat exchanger may, in particular, comprise at least one open cooling-fluid line through which the first cooling fluid flows. This open cooling-fluid line may be connected to the fluid heating device of the Peltier element at an outflow end. Furthermore, the cooling-fluid line may be connected to a cold-water connection at an inflow end. Between the inflow end and outflow end, the fluid heat exchanger may comprise, for example, cooling coils, cooling plates (for example, throughflow and/or flow-over cooling plates) and/or other types of known heat exchangers which are set up in order to extract the first heat quantity from the moist air.

Alternatively or additionally to a first fluid heat exchanger, the heat recovery device may also have at least one heat pump. This at least one heat pump preferably comprises a conventional heat pump, that is to say a compressor heat pump, which is based on the expansion and compression of fluids. Thus, by the conventional heat pump being combined with the at least one Peltier element, an optimal adaptation of the efficiencies can be achieved, for example in that the conventional heat pump precedes the at least one Peltier element in a direction of flow of the moist air. The at least one conventional heat pump and the fluid heating device may also have the same first cooling fluid flowing through them in succession.

The conventional heat pump can also be combined with the above-described at least one first fluid heat exchanger, so that the heat recovery device may also comprise the first fluid heat exchanger, the at least one heat pump and the at least one Peltier element. This combination is particularly preferable when the heat recovery device has a cascaded construction. Thus, the latter may comprise, in succession in a direction of flow of the moist air, first the at least one first fluid heat exchanger, then the at least one heat pump and subsequently the at least one Peltier element (or, as is to be covered by this with regard to its term, a second fluid heat exchanger which is in thermal contact with the Peltier element—see below). This cascade of elements of the heat recovery device may be constructed, in particular, in such a way that the same first cooling fluid flows in succession through the first fluid heat exchanger, the heat pump and the fluid heating device of the Peltier element. As described above, for this purpose, for example, a cooling-fluid line may be used which may be connected on the inflow side, for example, to a cold-water connection.

The advantage of this combination of a conventional heat pump, in particular of a compressor heat pump, with the Peltier element and, if appropriate, additionally with the first fluid heat exchanger is, in particular, as described above, a possibility of adapting optimal efficiencies. Particularly in the case of the cascade arrangement, each of the elements may be arranged and selected in such a way that it can operate in its optimal working range when the cleaning appliance is operating normally. Thus, for example, if the moist air has a temperature of approximately 60° C. upon entry into the heat recovery device, this can be cooled down, for example, to 40° C. in the at least one passive first fluid heat exchanger. By means of the compressor heat pump which can be optimized to this inlet temperature, a further cooling to, for example, 22 to 26° C. can then take place. By means of the at least one Peltier element, a further cooling to, for example, 15 to 20° C. can then take place in turn, so that, for example, a saturation point of the moisture load is reached. Optimal efficiencies and therefore optimal heat recoveries and dehumidification can thereby be achieved.

In order, particularly when exhaust air is cooled down, to avoid a condensation of moisture contained in the ambient air in the air cooled in this way and expelled from the cleaning appliance, which could, in turn, be detected as mist formation, preferably room air may additionally be admixed to the moist air in the heat recovery device. For this purpose, the heat recovery device may comprise, for example, a mixing device which admixes a room air to the moist air before discharge into the surroundings. For example, the mixing device may first suck in this room air, then admix this room air to the moist air upstream, between or downstream of the abovementioned elements of the fluid heat exchanger, of the heat pump and of the Peltier element and subsequently discharge this mixed air into the surroundings. Mist formation is prevented particularly effectively when admixing takes place downstream of the abovementioned elements of the fluid heat exchanger, the heat pump and the Peltier element in the direction of flow of the exhaust air. Admixing may take place, for example, using one or more mixing elements, for example vortex generators, fans or the like. A loading of the ambient air can thereby be reduced additionally.

As mentioned above, the at least one Peltier element can come into contact directly or indirectly with the moist air in order to extract the second heat quantity from the latter. A “direct” coupling may in this case be understood to mean, for example, a coupling in which the moist air flows, for example, directly over the heat-absorption side of the Peltier element and/or over a surface thermally coupled to this heat-absorption side. This may take place, for example, in a similar way to the embodiment described in DE 198 13 924 A1, in which the heat-absorbing surface is connected directly to the medium to be cooled. Even a more complex embodiment of the surface cooled directly by the Peltier element may be envisaged, for example in the form of an embodiment, likewise described in DE 198 13 924 A1, of the heat-absorption side in the form of large surfaces, for example in the form of chambers or interspaces through which the moist air can flow. Particularly efficient heat transmission is thus possible.

Within the scope of the present invention, however, it is particularly preferable if heat transmission from the moist air to the Peltier element takes place completely or partially indirectly. For this purpose, the heat recovery device may, for example, have, furthermore, at least one second fluid heat exchanger through which a second cooling fluid flows. As regards the possible embodiments of this cooling fluid, for example, reference may be made to the above description of the first cooling fluid, although, in this case, even a different configuration may be selected. In particular, it is preferable if this second cooling fluid is subsequently not used as a cleaning fluid, so that there is a greater freedom in terms of the choice of suitable materials for this second cooling fluid.

The second cooling fluid is preferably in thermal contact with the heat-absorption side of the Peltier element in at least one fluid cooling device. This thermal contact may be made, for example, by means of suitable heat transmission elements. Thus, for example, the second cooling fluid can first absorb the second heat quantity from the moist air and can then transport this second heat quantity towards the fluid cooling device where this second heat quantity is then transmitted to the Peltier element. Heat transmission between the moist air and the Peltier element thus takes place indirectly.

As described above, the at least one Peltier element may be configured in various ways. Thus, for example, individual Peltier elements may be used which may also be connected in parallel next to one another, for example in order to increase the effective surface of the heat-absorption side and/or of the waste-heat side (parallel arrangement). Alternatively or additionally to a parallel arrangement of individual Peltier elements, however, a stacking of a plurality of Peltier elements is also possible (stacked arrangement). Thus, advantageously, a plurality of Peltier elements may also be arranged, stacked, in a cascade-like manner in Peltier stacks, each with a heat-absorption side and a waste-heat side. This arrangement expediently takes place in such a way that in each case a heat-absorption side and in each case a waste-heat side of adjacent Peltier elements are in thermal contact with one another. Thus, for example, the temperature difference which can be achieved between the waste-heat side and heat-absorption side can be increased by means of a suitable stacking of the Peltier elements.

If Peltier stacks of the type described are used, but possibly also when individual Peltier elements are used, unstacked, then an advantageous embodiment, described below, in which a plurality of such individual Peltier elements and/or Peltier stacks are arranged alternately with regard to their heat-absorption sides and their waste-heat sides and are combined into a Peltier module, is possible. An “alternating arrangement” is to be understood in this case as meaning arrangements in which in each case the waste-heat sides of adjacent Peltier stacks face one another and/or in which in each case the heat-absorption sides of adjacent Peltier stacks face one another. Between the Peltier stacks, in each case heat exchange regions which are in thermal contact with the Peltier stacks can then be arranged. Thus, “face one another” is to be understood as meaning any arrangement in which at least two heat-absorption sides of different Peltier stacks face a heat exchange region or in which at least two waste-heat sides of different Peltier stacks face a heat exchange region, but, of course, even arrangements more complex than a linear arrangement of the Peltier stacks (for example, star-shaped arrangements) may be envisaged. In this case, in each case at least one first heat exchange region may be in thermal contact with at least two waste-heat sides of the Peltier stacks which are adjacent to this first heat exchange region. In each case at least one second heat exchange region may be arranged in such a way that it is in thermal contact with at least two heat-absorption sides of the Peltier stacks. Thus, for example, a layer structure may be provided, in which in each case heat exchange regions and Peltier stacks are arranged alternately. This may take place, for example, within the framework of a lamella-like set-up of the Peltier module, so that a particularly space-saving type of construction, at the same time with a high heat exchange efficiency, is possible. However, other types of set-up may also be envisaged.

The first heat exchange region may be utilized, for example, in order to transmit heat of the waste-heat side of individual Peltier elements or of the Peltier stacks to the first cooling fluid. Thus, the first heat exchange region may comprise, for example, at least one cavity. The first cooling fluid may flow through this first cavity. Within the framework of the lamella-like set-up described, these cavities may be configured, for example, as hollow plates through which the at least one first cooling fluid flows, so that a hollow area is available for the heat exchange.

Correspondingly, the at least one second heat exchange region may be utilized in order to transmit heat efficiently from the moist air to the heat-absorption sides of the Peltier elements or of the Peltier stacks. As described above, this may take place, for example, in that the second heat exchange region comprises at least one cavity (for example, once again, one or more cavities of hollow plates) through which the moist air flows directly. Alternatively or additionally, however, again, indirect heat exchange may also take place by means of a second cooling fluid. Thus, the second cooling fluid may, for example, again flow through the at least one cavity of the second heat exchange region (for example, hollow plates), so that particularly efficient heat transmission can take place. The hollow plates can be produced, for example, in that two plates of a highly thermally conductive material, such as, for example, aluminum, and/or a thermally conductive plastic, are connected or separated by means of a spacer element. For example, what may serve as a spacer element is a plastic injection moulding, to which, for example, required seals may also be attached (for example, in one piece, for example by means of a two-component injection-moulding method) in order to seal off the cavity. Advantageously, the cavity and/or the spacer element are/is designed in such a way that, for example, a meander-shaped cavity is present, thus prolonging the contact time between the cooling fluid and the hollow plates. This preferred embodiment may, alternatively or additionally, also be transferred to the other heat exchangers used within the scope of this invention.

As described above, a particular advantage in the use of Peltier elements in heat recovery devices is that, in contrast, for example, to conventional heat pumps, Peltier elements can be switched on and/or off and/or activated and/or regulated, for example regulated continuously, in a flexible way. This may be used in a deliberate way in order to control and/or monitor the functionality of the heat recovery device.

Thus, for example, the heat recovery device may have at least one temperature sensor for detecting a temperature of the moist air and/or at least one moisture sensor for detecting a moisture of the moist air. This at least one temperature sensor or moisture sensor may be arranged at various points in the air stream of the moist air. Thus, for example, at least one temperature sensor and/or moisture sensor may be arranged upstream of the heat exchanger or heat exchangers described above, within these elements and/or downstream of these elements, so that, for example, temperatures can be detected at various points. In particular, a final temperature can be detected which can monitor, for example, the temperature of the exhaust air before this is discharged into the surroundings and/or to an exhaust-air device (for example, an on-site exhaust-air pipe). If limit values are overshot, for example, warnings can be issued to a user and/or active processes, for example, control or regulation processes, can be initiated. In addition to one or more temperature sensors, alternatively or additionally, other types of sensors may also be provided, for example moisture sensors or other types of sensors.

It is particularly preferable if the heat recovery device comprises, furthermore, at least one electronic control device. This electronic control device, which, for example, may be integrated completely and/or partially into a central control apparatus of the cleaning appliance, but which may also be configured as an independent or decentral control apparatus, may be used for controlling the functionality of the heat recovery device. Thus, this electronic control apparatus may be used, for example for controlling and/or regulating the exhaust-air temperature and/or the exhaust-air moisture. For this purpose, the electronic control device may be set up, for example, in order to control and/or regulate a cooling capacity and/or heating capacity of the at least one Peltier element. For example, according to a control and/or regulating signal, an electrical current flowing through the at least one Peltier element can be controlled and/or regulated. If a plurality of Peltier elements are provided, these may, for example, also be switched on or off individually or in groups, as required, and/or be regulated, for example again continuously, individually or in groups by means of individual current action. Thus, the heat recovery device may comprise a plurality of Peltier elements, while the cleaning appliance may be set up in order to control the Peltier elements individually or in groups, in particular to act upon them with a current individually or in groups, and/or to switch them on and off individually or in groups.

As described above, the invention can be used, in particular, within the framework of commercial cleaning appliances, in particular commercial dishwashers. In particular, it is preferable if the fluid tank comprises a boiler and/or a flow heater. As described above, the cleaning appliance may comprise, for example, a flow-type dishwasher with at least one cleaning zone, the cleaning stock running through this at least one cleaning zone in a flow direction. The at least one cleaning zone may comprise, for example, at least one pump rinsing zone and/or one fresh-water rinsing zone which, as a rule, has a particularly high temperature of the cleaning fluid (rinsing liquid), for example a temperature of approximately 85° C. Consequently, in particular, the pump rinsing tank of the pump rinsing zone and/or use in the fresh-water rinsing zone (for example, in the form of a direct supply and/or in the form of a supply to a fresh-water rinsing tank) are/is suitable for heat recirculation.

In addition to the at least one cleaning zone, the flow-type dishwasher may have, furthermore, at least one drying zone which preferably follows the at least one cleaning zone in the flow direction. This drying zone may have, in particular, a blower in order to act with hot air upon the cleaning stock. It is particularly preferable, in this case, if the blower and the suction-extraction device are set up or interact in such a way that an air stream opposite to the flow direction is formed during operation in the flow-type dishwasher. This development of the invention has, in particular, the advantage that the moist air is conducted opposite to the flow direction within the cleaning zones with an increase in absorption of moisture, in order finally to be suction-extracted, for example in a first cleaning zone. The moist air is thus saturated to a maximum with water vapor, which constitutes the most beneficial configuration for heat recovery.

In addition to the cleaning appliance in one of the above-described embodiments, furthermore, a method for heat recovery in a cleaning appliance is proposed. This method can be used, in particular, in a cleaning appliance according to one of the embodiments described above, and therefore reference may largely be made to the above description for possible exemplary embodiments of the cleaning appliance. However, in other embodiments of cleaning appliances, too, the method may, in principle, be employed.

The cleaning appliance is set up in order to act with at least one cleaning fluid upon the cleaning stock, the cleaning appliance having at least one heat recovery device which is set up in order to extract heat from the moist air. As described above, the heat recovery device has at least one Peltier element which has at least one heat-absorption side and at least one waste-heat side. The method is carried out in such a way that heat is extracted from moist air out of the cleaning appliance by means of the absorption side, the waste-heat side of the Peltier element being cooled by means of a first cooling fluid. This first cooling fluid is subsequently conducted into the fluid tank in order to supply the heat absorbed on the waste-heat side of the Peltier element to the cleaning appliance at least partially again. This cooling fluid may subsequently be used, for example, for cleaning the cleaning stock. This reuse may take place, for example, continuously and/or also sequentially, depending on the configuration of the cleaning appliance.

As likewise described above, the heat recovery device may also be of cascaded or multi-stage design. Thus, the heat recovery device may have, for example, at least one first fluid heat exchanger which is set up in order to extract a first heat quantity from the moist air. The heat-absorption side of the Peltier element may be set up in order to extract a second heat quantity from the moist air, the first cooling fluid first flowing through the first fluid heat exchanger and subsequently cooling the waste-heat side of the Peltier element.

As likewise described above, the method may advantageously be developed, furthermore, in such a way that a temperature and/or a moisture of the moist air after it flows through the heat recovery device are/is controlled and/or regulated, particularly in that at least one cooling capacity of the Peltier element is controlled and/or regulated. Furthermore, the method may be carried out in such a way that a temperature on the heat-absorption side and/or a temperature on the waste-heat side are/is controlled and/or regulated. For this purpose, for example, once again, one or more temperature sensors and/or moisture sensors may be provided. In this case, “control and/or regulation” may be understood, for example, as meaning a setting to a desired value and/or a desired range. Thus, for example, minimum temperatures which should not be undershot and/or maximum temperatures which should not be overshot may be predetermined and be regulated/controlled, for example, by the electronic control as a result of the setting of, for example, one or more currents through the Peltier element. In particular, a temperature of the first cooling fluid can be controlled and/or regulated, for example limited downwards and/or upwards. Thus, for example, an overheating of the fluid tank can be avoided. Alternatively or additionally, as described above, the heat recovery device may have, furthermore, the at least one second fluid heat exchanger through which flows the second cooling fluid which, in the at least one fluid cooling device, is in thermal contact with the heat-absorption side of the Peltier element. In this case, for example, a temperature of the second cooling fluid can also be controlled and/or regulated, particularly limited downwards and/or upwards. This may be utilized, for example, in order to avoid an icing-up of the second fluid heat exchanger.

Further details and features of the invention may be gathered from the following description of preferred exemplary embodiments, in conjunction with the subclaims. In this case, the respective features may be implemented alone in themselves or severally in combination with one another. The invention is not restricted to the exemplary embodiments. The exemplary embodiments are illustrated diagrammatically in the figures. The same reference numerals in the individual figures designate in this case identical or functionally identical elements or elements corresponding to one another in terms of their functions.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an exemplary embodiment of a cleaning appliance in the form of a flow-type dishwasher;

FIG. 2 shows a diagrammatic illustration of an exemplary embodiment of a heat recovery device;

FIG. 3 shows a possible exemplary embodiment of a Peltier arrangement; and

FIG. 4 shows an exemplary embodiment, alternative to FIG. 2, of a heat recovery device with an additional heat pump.

### DETAILED DESCRIPTION

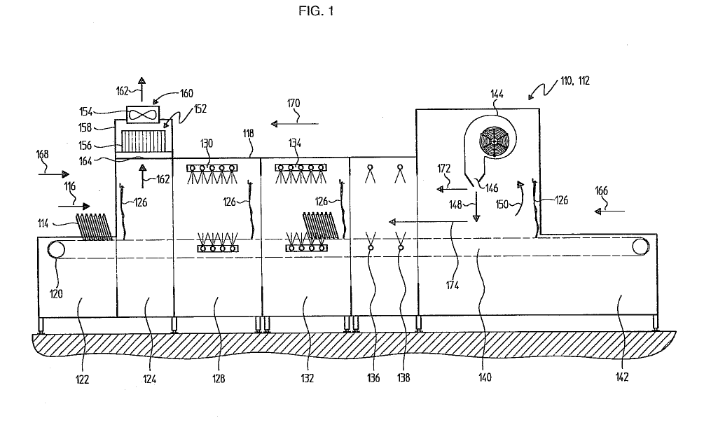

FIG. 1 illustrates a possible exemplary embodiment of a cleaning appliance 110 according to the invention. This cleaning appliance is configured in this exemplary embodiment as a flow-type dishwasher 112. For the set-up and the functioning of this flow-type dishwasher 112, reference may be largely made to DE 10 2004 003 797 A1.

In the flow-type dishwasher 112, cleaning stock 114 runs in a flow direction 116 through a cleaning chamber 118. In the flow-type dishwasher 112 illustrated, the transport of the cleaning stock takes place by means of a transport belt 120. The flow-type dishwasher 112 is therefore configured as a belt-transport dishwasher.

At an entry 122, cleaning stock 114 received on the top side of the transport belt 120 runs into an entry tunnel 124. The entry tunnel 124 is screened off outwardly by means of a separating curtain 126, in order to prevent the emergence of steam vapors in the region of the entry tunnel 124 of the flow-type dishwasher 112. After the cleaning stock 114 received on the top side of the transport belt 120 has passed through the entry tunnel 124, it enters the cleaning chamber 118 which is subdivided into a plurality of cleaning zones. First, the cleaning stock 114 is transported into a pre-washing zone 128. A pre-washing system 130 is arranged inside the pre-washing zone 128. The pre-washing system 130 has spray pipes which are arranged on the underside of or above the revolving transport belt 120. Via a variable-power pump, not illustrated in FIG. 1, the pre-washing system 130 is acted upon with cleaning fluid, depending on the degree of soiling of the cleaning stock 114. The pre-washing zone 128 is separated from a following washing zone 132 by a further separating curtain 126. After passing through the pre-washing zone 128, the cleaning stock 114 runs into the washing zone 132. The washing zone 132 likewise comprises a washing system, designated by the reference symbol 134. The washing system 134 is arranged above and below the top side of the revolving transport belt 120. The washing zone 132 is separated by a further separating curtain 126 from a pump rinsing zone 136 which has a washing system arranged above and a washing system arranged below the top side of the transport belt 120 and taking the form of two spray pipes lying opposite one another. The pump rinsing zone 136 is followed by a fresh-water rinsing zone 138. Within the fresh-water rinsing zone 138, the cleaning stock 114 is rinsed with fresh water, in order to remove from the latter impurities which have remained or the previously applied cleaning fluid before the cleaning stock enters a drying zone 140. The fresh-water rinsing zone 138 is followed by a further separating curtain 126 (not illustrated in FIG. 1) which separates the fresh-water rinsing zone 138 from the drying zone 140.

Within the drying zone 140, which is followed by a take-off stage 142, is located a drying blower 144. The drying blower 144 sucks in air and heats this. The air heated in the drying blower 144 enters an outlet funnel 146, on the lower end of which is located an outlet nozzle which deflects the emerging drying air onto the cleaning stock 114 passing through the drying zone 144. Below the drying zone 144, a deflection surface may be provided, which deflects the hot air emerging in the outlet direction 148 from the outlet nozzle in the direction of flow 150, so that this hot air partially flows to the drying blower 144 again. As seen in the flow direction 116 of the cleaning stock 114, the drying zone 144 is screened off from the take-off stage 142 by a further separating curtain 126.

During the transport of the cleaning stock 114 through the flow-type dishwasher 112 illustrated in FIG. 1, its temperature increases continuously. The temperature of the cleaning stock 114 in the pre-washing zone 128 rises from room temperature, for example, to a temperature of 40° C. to 45° C., in the following washing zone 132 to 55° C. to 65° C., and, in the following pump rinsing zone 136 or fresh-water rinsing zone 138, to a temperature of between 60° C. and 85° C.

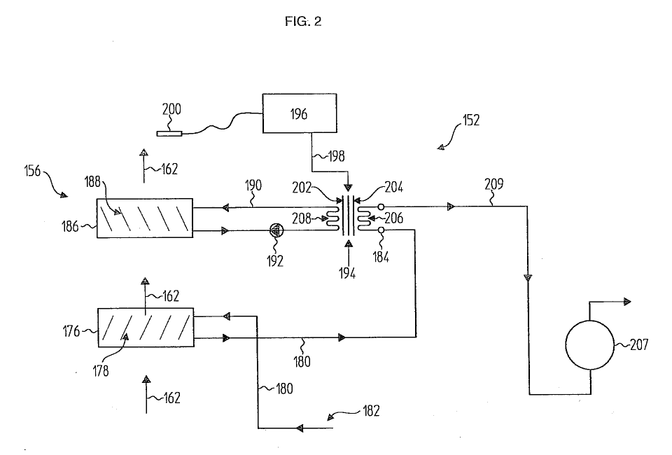

The flow-type dishwasher 112 has a heat recovery device 152 which comprises a blower 154 and a heat exchange device 156. Both are arranged in a shaft 158 which issues into an exhaust-air orifice 160 in the region of which the blower 154 is arranged. In this exemplary embodiment, the shaft 158 is arranged in the region above the entry tunnel 124. The configuration of the heat exchange device 156 and of the heat recovery device 152 is explained in more detail below with reference to FIGS. 1 and 2. Via the blower 154 assigned to the heat recovery device 152, a vacuum is generated within the flow-type dishwasher 112 and allows the section-extraction of an exhaust-air stream 162 at a suction-extraction point 164. As illustrated above, in the present exemplary embodiment this suction-extraction point 164 is arranged above the entry tunnel 124, but other embodiments are also possible, for example arrangements of the suction-extraction point 164 in one or more of the cleaning zones 128, 132, 136 or 138. The section-extraction of the exhaust-air stream 162 at the suction-extraction point 164 prevents steam vapors from emerging from the flow-type dishwasher 112 at the entry 122 and at the take-off stage 142. This purpose is served, on the one hand, by the separating curtains 126 arranged there and, on the other hand, by the blower 154 generating a vacuum. Below the separating curtains 126 at the entry tunnel 124 and at the take-off stage 142 are located gap-shaped orifices, via which in each case outside-air streams 166, 168 enter the flow-type dishwasher 112 and correspond to the overall volume of the exhaust-air stream 162. The air routing within the flow-type dishwasher 112 according to the illustration in FIG. 1 is selected in such a way that the exhaust-air stream 162 flows through the various cleaning zones 128, 132, 136, 138 through which the cleaning stock 114 runs, opposite to the flow direction 116, as indicated by the reference symbol 170. The flow 170 of the exhaust-air stream 162 is routed, on the one hand, through the blower 154 assigned to the heat recovery device 152 and, on the other hand, through the drying blower 144. The drying blower 144 may preferably have a variable configuration. Depending on the inclination of the outlet nozzles of the drying blower 144, for example, a first, smaller air quantity 172 or a second, larger air quantity 174 can be drawn off from the drying zone 140. These air quantities 172, 174 can be set by means of a corresponding control of the drying blower 144 and of the blower 154, so that no steam vapors can emerge from the flow-type dishwasher 112.

For further possible embodiments of the flow-type dishwasher 112, reference may be made, for example, to DE 10 2004 003 797 A1, which corresponds to U.S. Publication No. 20070131260, and which is incorporated herein by reference. It may be pointed out, however, that the cleaning appliances 110 may also be configured in another way, for example with an individual cleaning chamber which is equipped with a heat recovery device 152. An embodiment with a plurality of cleaning chambers, in each of which one or more heat recovery devices are provided, may also be envisaged. A further example of a possible embodiment of the cleaning appliance 110 is a hood-type dishwasher. Thus, for example, the heat recovery device 152 according to FIG. 2 (see below) could also be mounted on a hood and/or a rear wall and/or in an undercarriage of a hood-type dishwasher, for example of a push-through hood-type dishwasher. An example of such hood-type dishwashers in which the heat recovery device 152 can be used is described in DE 10 2005 046 733 A1. The heat recovery device 152 could be used there, for example, instead of or in addition to the heat exchanger disclosed there.

FIG. 2 illustrates diagrammatically a possible exemplary embodiment of the heat recovery device 152 which may be used, for example, in the cleaning appliance 110 according to FIG. 1. What is not illustrated in this case is the blower 154 which causes the exhaust-air stream 162 of hot moist air through a heat exchange device 156 and/or another type of device which is conducive to the discharge of this moist air.

The heat exchange device 156 comprises a first fluid heat exchanger 176 which is merely indicated in FIG. 2. This first fluid heat exchanger 176 may comprise, for example, a multiplicity of first heat exchanger surfaces 178 which may be configured, for example, in the form of cooling coils, cooling surfaces, throughflow and/or flow-over cooling plates, lamellae or in a similar way known to a person skilled in the art. Furthermore, the first fluid heat exchanger 176 has a cooling-fluid line 180 with an inflow end 182 and with an outflow end 184. A first cooling fluid can flow through the first fluid heat exchanger 176 from the outflow end 184, and then flows through the first heat exchanger surfaces 178, in order finally to flow to the outflow end 184. The inflow end 182 may, for example, be connected to a cold-water connection (fresh water).

The heat exchange device 156 has, furthermore, a second fluid heat exchanger 186. This second fluid heat exchanger 186 may basically be configured similarly to the first fluid heat exchanger 176 and, for example, may have, once again, second heat exchanger services 188. These may again have, for example, throughflow or spray-over cooling surfaces, cooling coils, lamellae or similar types of heat exchanger surfaces to those which may also be used in the first exchanger surfaces 178. The second fluid heat exchanger 186 comprises a heat exchanger circuit 190 through which a second cooling fluid flows, so that the second fluid heat exchanger 186 forms, overall, a closed system in which a second cooling fluid can circulate. This circulation may be assisted, for example, by a pump 192 in the heat exchanger circuit 190. It may be pointed out that pumps, valves or similar devices driving or controlling the fluid movement, which are not illustrated in FIG. 2, may also be received at other locations in the heat recovery device 152 illustrated in FIG. 2.

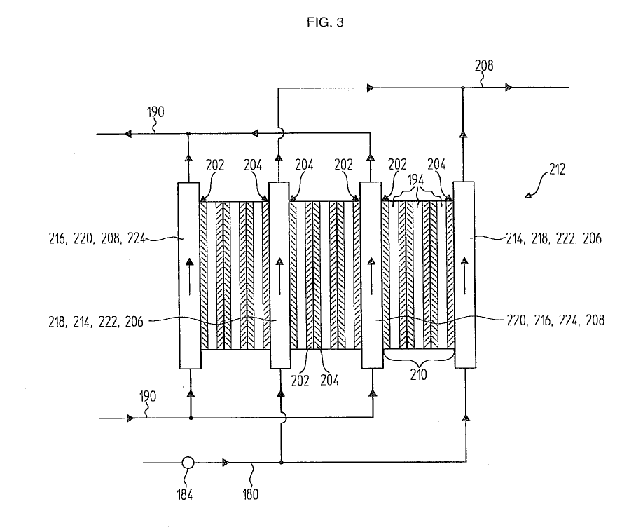

Furthermore, the heat exchange device 156 comprises Peltier elements 194 which are merely indicated in FIG. 2, and, for its more detailed set-up, reference may be made, for example, to the bottom of FIG. 3. The Peltier elements 194 are supplied with electrical energy, for example acted upon with an electrical current, by means of an electronic control device 196. This is indicated symbolically in FIG. 2 by the control line 198. Furthermore, optionally, the electronic control device 196 is connected to a temperature sensor 200, for example a temperature-dependent precision resistor which is arranged in the exhaust-air stream 162 on the outflow side of the second fluid heat exchanger 186. Alternatively or additionally to this arrangement of the temperature sensor 200, other arrangements of temperature sensors and/or arrangements of moisture sensors (not illustrated) may also be selected, for example arrangements between the first fluid heat exchanger 176 and the second fluid heat exchanger 186 and/or an arrangement upstream of the first fluid heat exchanger 176.

The Peltier elements 194 have a heat-absorption side 202 and a waste-heat side 204. During operation, the Peltier elements 194 act in such a way that heat is “pumped” (thermoelectric heat pump) from the heat-absorption side 202 to the waste-heat side 204.

On the waste-heat side 204, a fluid heating device 206 is provided, which is indicated merely symbolically in FIG. 2 and for the implementation of which reference may be made, for example, to FIG. 3. This fluid heating device 206 is connected to the outflow end 184 of the cooling-fluid line 180, so that the first cooling fluid can flow through the fluid heating device 206. The fluid heating device 206 is in thermal contact with the waste-heat side 204, so that heat can be transmitted from this waste-heat side 204 to the first cooling fluid. The fluid heating device 206 is connected to a fluid tank 207 via a discharge line 209. This fluid tank 207 may be configured, for example, as a boiler and/or as a flow heater, but may also be configured without an additional heating device. The fluid tank 207 may be assigned, for example, to one of the cleaning zones 128, 132, 136, 138 described above, assignment to the pump rinsing zone 136 and/or to the fresh-water rinsing zone 138 being particularly preferred. In particular, assignment to the fresh-water rinsing zone 138 is advantageous, since the highest temperatures are required here, and since energy saving can be carried out efficiently by utilizing the waste heat from the moist air of the exhaust-air stream 162 for heating up the fluid tank 207.

As described above, by contrast, the heat exchanger circuit 192 of the second fluid heat exchanger 186 is configured as a closed circuit. The heat exchanger circuit 190 is connected to a fluid cooling device 208 which is indicated likewise merely diagrammatically in FIG. 2 and for the exemplary embodiment of which reference may be made to FIG. 3. In this fluid cooling device 208, a second heat exchanger fluid, after flowing through the second heat exchanger surfaces 188 and after the absorption of a heat quantity from the exhaust-air stream 162, can emit this absorbed second heat quantity to the heat-absorption side 202 of the Peltier elements 194.

The heat recovery device 152 and its heat exchange device 156 are therefore of two-stage design in the present exemplary embodiment according to FIG. 2. In the first fluid heat exchanger 176, the first cooling fluid flowing through the cooling-fluid line 180 absorbs a first heat quantity. In the second fluid heat exchanger 186, the moist air of the then already slightly cooled exhaust-air stream 162 transmits a second heat quantity to the second cooling fluid circulating through the heat exchanger circuit 190. This second heat quantity is transmitted additionally, plus waste-heat capacities of the Peltier elements 194 and minus heat loss quantities due to the Peltier elements 194, to the first cooling fluid flowing through the cooling-fluid line 180, so that the said first cooling fluid is additionally heated up.

For example, the moist air of the exhaust-air stream 162 may have a temperature in the range of between 80 and 90° C. before entering into the heat exchanger device 156. On the side of the inflow end 182, the first cooling fluid, for example cold water, may have a temperature of, for example, 10° C. On the side of the outflow end 184, that is to say after passing through the first heat exchanger surfaces 178, the first fluid can be heated to a temperature of approximately 60° C. After passing through the fluid heating device 206, finally, the first cooling fluid may be heated to temperatures of 70° C. to 85° C. or more, so that an optimal temperature is reached in the discharge line 209 to the fluid tank 207. The second cooling fluid in the heat exchanger circuit 190 may, for example before flowing through the second heat exchanger surfaces 188, have a temperature of approximately 10° C. due to cooling in the fluid cooling device 208. In the second heat exchanger surfaces 188, this second cooling fluid is then heated slightly, for example to a temperature of 12° C. In contrast to straightforward liquid heat exchangers, this slight heating and absorption of a second heat quantity are sufficient to be transmitted to the first cooling fluid by the Peltier elements 194. On the outflow side, the exhaust-air stream 162, after emerging from the second fluid heat exchanger 186, may set a temperature of, for example, 15°. This temperature can, for example, be controlled and/or regulated independently of the inlet temperature of the exhaust-air stream 162 and/or independently of the inlet temperature of the first cooling fluid at the inflow end 182. For this purpose, the electronic control device 196 can, for example, according to the signal from the temperature sensor 200, activate the Peltier elements 194 correspondingly, in order to raise or lower the cooling capacity.

It may be pointed out that the numerical values mentioned are to be understood as being merely by way of example, and that other temperature configurations are also possible. Alternatively or additionally to the two-stage configuration, illustrated here, of the heat recovery device 152, cascades with more than two stages may also be envisaged, for example in that further fluid heat exchangers are provided.

FIG. 3 shows an enlarged illustration of the Peltier elements 194 and also of the fluid heating device 206 and the fluid cooling device 208 which may be used, for example, in FIG. 2. It is shown, in this case, that the individual Peltier elements 194 are assembled in this exemplary embodiment into Peltier stacks 210. In this exemplary embodiment, each Peltier stack 210 contains, for example, three Peltier elements 194, these Peltier elements 194 being assembled in such a way that the in each case one heat-absorption side 202 of a first Peltier element 194 is adjacent to a waste-heat side 204 of an adjacent Peltier element 194 (“head-to-tail arrangement”). Thus, correspondingly, each Peltier stack 210 has a waste-heat side 204 and a heat-absorption side 202. The arrangement of a plurality of Peltier elements 194 in Peltier stacks 210 makes it possible to have a higher temperature difference between waste-heat side 204 and heat-absorption side 202 than would be possible with individual Peltier elements 194. In the exemplary embodiment according to FIG. 3, once again, a plurality of Peltier stacks 210 (in this case, three Peltier stacks 210) are combined into a Peltier module 212. In this case, in this exemplary embodiment, the three Peltier stacks 210 are oriented in a “head-to-head” arrangement with respect to one another, so that, for example, the waste-heat side 204 of the left-hand Peltier stack 210 faces the waste-heat side 204 of the middle Peltier stack 210. The heat-absorption side 202 of the middle Peltier stack 210, once again, faces the heat-absorption side 202 of the right-hand Peltier stack 210. On the outsides and between the Peltier stacks 210 are arranged here in each case exchanger plates 214, 216 which alternately form first heat exchange regions 218 and second heat exchange regions 220. While the first exchanger plates 214 or the first heat exchange region 218 are in thermal contact with the waste-heat sides 204 of the Peltier stacks 210, the second exchanger plates 216 or the second heat exchange regions 220 are in thermal contact with the heat-absorption sides 202 of the Peltier stacks 210. The exchanger plates 214, 216 have first and second cavities 222, 224 through which the first cooling fluid and the second cooling fluid can flow respectively. Correspondingly, the first cavities 222 are connected to the cooling-fluid line 180 or the discharge line 209, whereas the second cavities 224 are connected to the heat exchanger circuit 190. The first heat exchange regions 218 thus form the fluid heating device 206, whereas the second heat exchange regions 220 form the fluid cooling device 208.

The Peltier stacks 210 and the exchanger plates 214, 216 may be held together, for example, by means of connection elements, not illustrated in FIG. 3, for example screws, staples or the like. Thus, efficient heat transmission from the second cooling fluid to the first cooling fluid, with the Peltier elements 194 interposed, can take place.

It may be pointed out that the arrangement of the Peltier elements 194 which is illustrated in FIG. 3 constitutes only one of many possible exemplary embodiments. Other arrangements may also be envisaged, for example arrangements in which a plurality of Peltier elements 194 are arranged next to one another or alternatively or additionally to a stack, so as to form as large exchange surfaces as possible for heat transmission. Modules can thus be produced which, for example, may form surfaces with edge lengths having a few 10 cm. In addition to the “head-to-head” arrangement described above, non-linear arrangements, for example star-shaped arrangements, may also be envisaged. Furthermore, another type of throughflow of the Peltier modules 212 may be selected, and further devices may be provided in order to increase the surface additionally. The efficiency of heat transmission can thus be improved additionally by means of a suitable arrangement.

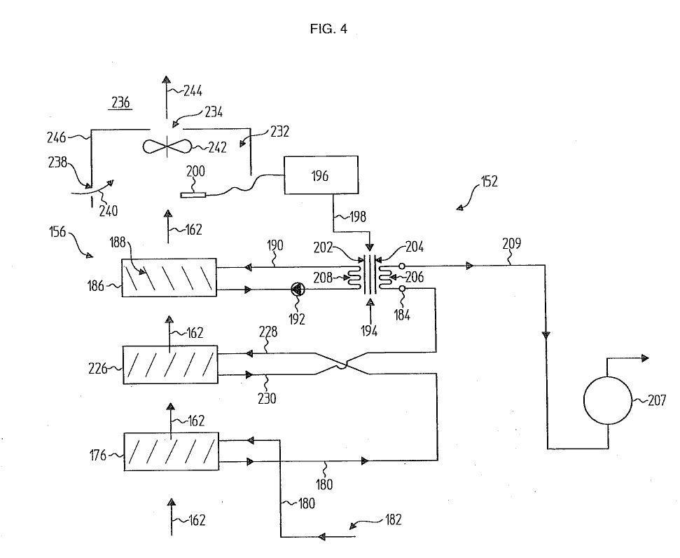

FIG. 4 illustrates diagrammatically an exemplary embodiment of a heat recovery device 152 which is alternative to FIG. 2. This heat recovery device 152 initially corresponds essentially to the heat recovery device 152 according to FIG. 2, and therefore reference may largely be made to the description of FIG. 2 with regard to possible embodiments and details and with regard to functioning.

In contrast to the embodiment according to FIG. 2, however, in the heat recovery device 152 according to FIG. 4, a conventional heat pump 226, for example a compressor heat pump, is additionally provided. The first fluid heat exchanger 176, that is to say the passive heat exchanger, the heat pump 226 and the second fluid heat exchanger 186 are in this case connected one behind the other in a cascaded manner with respect to the direction of flow of the exhaust-air stream 162.

The heat quantity recovered by the heat pump 226 could be supplied separately to the cleaning appliance 110 again, for example via a corresponding cooling fluid and a separate cooling-fluid line. It is particularly advantageous, however, if the first cooling fluid is also utilized for discharging the heat obtained by the heat pump 226, so this first cooling fluid in the cooling-fluid line 180 is heated in succession by the first fluid heat exchanger 176, the heat pump 226 and the second fluid heat exchanger 186 or the fluid heating device 206 and the Peltier elements 194 in order to allow a step-by-step heating of this first cooling fluid and to make it possible to have an optimal adaptation of the efficiencies of the individual elements of the heat recovery device 152 to the current temperature of the cooling fluid.

For this purpose, according to the exemplary embodiment in FIG. 4, the heat recovery device 152 is configured in such a way that the first cooling fluid flows first through the first fluid heat exchanger 176, then through the heat pump 226 and finally through the fluid heating device 206. The heat pump 226 is thus incorporated into the cooling-fluid line 180, so that an inflow 228 of the heat pump 226 is connected to the first fluid heat exchanger 176 and an outflow 230 of the heat pump 226 is connected to the fluid heating device 206.

Thus, as illustrated above, the stream of moist air 162 from the cleaning appliance 110 can, for example, be cooled down first in the passive first fluid heat exchanger 176 from approximately 60° to, for example, 35 to 45° C., preferably approximately 40° C. A further cooling, for example to a temperature of between 20 and 30° C., for example 22 to 26° C., can then take place in the heat pump 226. A further cooling, for example to a temperature of 15 to 20° C., in particular approximately 15 to 18° C., can then take place by means of the Peltier elements 194 or the second fluid heat exchanger 186.

Furthermore, FIG. 4 shows an optional configuration of the heat recovery device 152 which, for example, could also be implemented in the example according to FIG. 2 and which could be used independently of the presence of the heat pump 226 and of the first fluid heat exchanger 176. This option comprises a mixing device 232 which is merely indicated diagrammatically in FIG. 4. This mixing device is intended, in particular, to prevent mist formation at an outlet 234 if excessively cooled air is discharged into the surroundings 236. For this purpose, the mixing device has an ambient-air intake 238, through which ambient air 240 can be sucked into the mixing device 232. This ambient-air intake 238 may, for example, comprise, as illustrated in FIG. 4, a simple orifice into which ambient air 240 is sucked, for example by means of a blower 242. An intermixing of the air 162 from the cleaning appliance 110 with the ambient air 240 then takes place inside the mixing device 232. This intermixing, too, may take place, for example, by means of the blower 242, but separate mixing devices, for example in the form of separate swirlers, blowers, fans or the like, are also provided. Thus, relative moisture of the exhaust-air stream 244 which is subsequently expelled or discharged into the surroundings 236 can be reduced considerably. The temperature can thereby also be adapted to the temperature of the surroundings 236, so that mist formation can be reduced or avoided completely.

The mixing device 232 may comprise, for example, a specific housing 246 and, for example as a separate attachment, may be placed jointly or separately with the heat recovery device 152 onto the cleaning appliance 110 and/or mounted on this.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

1. A cleaning appliance for the cleaning of cleaning stock, the cleaning appliance configured in order to act with at least one cleaning fluid upon the cleaning stock in at least one cleaning chamber, the cleaning appliance comprising:
at least one fluid tank for storing the cleaning fluid;
a suction-extraction device for the section-extraction of moist air from the cleaning chamber; and
at least one heat recovery device configured to extract heat from the moist air, the heat recovery device having at least one Peltier element having a heat-absorption side and a waste-heat side, the waste-heat side being in thermal contact with a fluid heating device, the fluid heating device being in contact with a first cooling fluid and configured to heat the first cooling fluid,
wherein the cleaning appliance is configured to use the first cooling fluid for a cleaning process.

2. The cleaning appliance according to claim 1, wherein the heat recovery device has at least one first fluid heat exchanger, the first fluid heat exchanger configured to extract a first heat quantity from the moist air, and wherein the heat-absorption side of the Peltier element configured to extract a second heat quantity from the moist air.

3. The cleaning appliance according to claim 2, wherein the first cooling fluid flows through the first fluid heat exchanger, and wherein the first cooling fluid, after flowing through the first fluid heat exchanger, flows through the fluid heating device.

4. The cleaning appliance according to claim 2, wherein the first fluid heat exchanger comprises at least one open cooling-fluid line through which the first cooling fluid flows and wherein an outflow end of the cooling-fluid line is connected to the fluid heating device.

5. The cleaning appliance according to claim 4, wherein an inflow end of the cooling-fluid line is connected to a cold-water connection.

6. The cleaning appliance according to claim 1, wherein the heat recovery device has at least one heat pump that is configured to extract a third heat quantity from the moist air.

7. The cleaning appliance according to claim 1, wherein the heat recovery device comprises at least one first fluid heat exchanger, at least one heat pump, in particular a compressor heat pump, and the at least one Peltier element.

8. The cleaning appliance according to claim 7, wherein the heat recovery device is formed in a cascaded manner and comprises, in succession, in a direction of flow of the moist air, the at least one first fluid heat exchanger, the at least one heat pump, and the at least one Peltier element.

9. The cleaning appliance according to claim 7, wherein the first cooling fluid flows through the first fluid heat exchanger and wherein the first cooling fluid, after flowing through the first fluid heat exchanger, flows through the heat pump, and wherein the first cooling fluid, after flowing through the heat pump, flows through the fluid heating device.

10. The cleaning appliance according to claim 1, wherein the heat recovery device further comprises at least one mixing device that is configured to admix an ambient air to the moist air before the discharge of the moist air into the surroundings.

11. The cleaning appliance according to claim 10, wherein the heat recovery device further comprises at least one second fluid heat exchanger, wherein a second cooling fluid flows through the second fluid heat exchanger, and wherein the second cooling fluid is in thermal contact, in at least one fluid cooling device, with the heat-absorption side of the Peltier element.

12. The cleaning appliance according to the claim 11, wherein the second fluid heat exchanger has a heat exchanger circuit through which the second cooling fluid flows, the heat exchanger circuit comprises at least one heat exchanger region, which is in contact with the moist air, and the fluid cooling device.

13. The cleaning appliance according to claim 1, wherein a plurality of Peltier elements are arranged, stacked in a cascade-like manner in Peltier stacks, each with a heat-absorption side and each with a waste-heat side.

14. The cleaning appliance according to claim 13, wherein a plurality of Peltier stacks are arranged alternately with respect to their heat-absorption sides and to their waste-heat sides and are combined into a Peltier module, in each case heat exchange regions being arranged between the Peltier stacks, in each case at least one first heat exchange region being in thermal contact with at least two waste-heat sides of the Peltier stacks, and in each case at least one second heat exchange region being in thermal contact with at least two heat-absorption sides of the Peltier stacks.

15. The cleaning appliance according to claim 14, wherein the first heat exchange region and/or the second heat exchange region comprises at least one cavity, the first fluid flowing through the cavity of the first heat exchange region.

16. The cleaning appliance according to claim 11, wherein the second cooling fluid is in thermal contact with the heat-absorption side, in particular flows through the cavity of the second heat exchange region.

17. The cleaning appliance according to claim 15, wherein the moist air flows completely or partially through the cavity of the second heat exchange region.

18. The cleaning appliance according to claim 1, wherein the heat recovery device further comprises at least one temperature sensor for detecting a temperature of the moist air and/or at least one moisture sensor for detecting a moisture of the moist air.

19. The cleaning appliance according to claim 1, wherein the cleaning appliance further comprises:
at least one flow-type dishwasher having at least one cleaning zone and configured such that the cleaning stock runs through the cleaning zone in a flow direction, the at least one cleaning zone comprising at least one rinsing zone with at least one rinsing tank, wherein the first cooling fluid, after flowing through the fluid heating device, is routed into the rinsing tank.

20. A method for heat recovery in a cleaning appliance, the cleaning appliance configured to act with at least one cleaning fluid upon a cleaning stock, the cleaning appliance, the method comprising:
extracting heat from moist air out of the cleaning appliance via at least one heat recovery device, the heat recovery device having at least one Peltier element having a heat-absorption side and a waste-heat side, the moist air being extracted via the heat-absorption side;
cooling the waste-heat side of the Peltier element by at least one first cooling fluid; and
supplying the first cooling fluid subsequently to a cleaning process proceeding in the cleaning appliance in order to supply the heat absorbed on the waste-heat side of the Peltier element to the cleaning appliance at least partially again.

21. The method according to claim 20, wherein the heat recovery device has at least one first fluid heat exchanger, the first fluid heat exchanger configured to extract a first heat quantity from the moist air, wherein the heat-absorption side of the Peltier element is configured to extract a second heat quantity from the moist air, and wherein the first cooling fluid first flows through the first fluid heat exchanger and subsequently cools the waste-heat side of the Peltier element.

22. The method according to claim 20, wherein a temperature and/or a moisture of the moist air, after flowing through the heat recovery device is controlled and/or regulated in that at least one cooling capacity of the Peltier element is controlled and/or regulated.

23. The method according to claim 20, wherein a temperature on the heat-absorption side and/or a temperature on the waste-heat side is controlled and/or regulated.
